(19) United States
(12) Patent Application Publication
(10) Pub. No.: US 2005/0056365 A1
(43) Pub. Date: Mar. 17, 2005

(54) Thermal interface adhesive

(76) Inventor: Albert Chan, San Jose, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/663,207

(22) Filed: Sep. 15, 2003

(51) Int. Cl. B32B 31/26

(52) U.S. Cl. 156/307.7; 252/519.33

(57) ABSTRACT

A thermally conductive interface adhesive for attaching an electronic component, such as an integrated circuit chip, to a heat receiving substrate, such as a heat spreader, is disclosed. The interface adhesive comprises a mixture of solder powder, flux and a curable polymer, such as an epoxy, which form a paste. Preferably, the interface adhesive further comprises particles of a metallic filler material, such as silver or copper. Preferably, the solder has a relatively low melting point, and the polymer is thermosetting. After the adhesive paste is applied it is processed by heating it to melt the solder after which the polymer is cured, such that a metallic network is formed within the adhesive layer. The cured adhesive layer has a thermal conductivity of about 15 W/m-K or more.

### FIELD OF THE INVENTION

The present invention is directed to thermally conductive adhesives and is more specifically directed to adhesives for joining electronic components to substrates for rapid heat dissipation.

### BACKGROUND OF THE INVENTION

In many electronic devices it is necessary or desirable to attach an electronic component to a substrate or other surface using an adhesive. In many situations, the electronic component being attached produces heat which dissipates, at least in part, by conduction through the adhesive to the substrate or other surface which is used to receive the heat from the component. As an example, the electronic component might be an integrated circuit (“IC”) chip, and the substrate might be a heat spreader or heat sink.

As the speed and power of IC chips and other electronic components has increased, the need for adhesives with improved thermal conductivity has increased so that improved heat dissipation through the adhesive can be achieved. For example, current high performance microprocessors are operating at power levels in excess of 100 W, and even higher power levels are expected to become common in the near future. Thus, there is a current need for a thermal interface adhesive with a thermal conductivity above 15 W/m-K, and this need will likely increase over time. Currently available thermal interface adhesives generally have thermal conductivities less than 10 W/m-K.

In many applications, electronic components are subjected to thermal cycling, i.e., the temperature of the components undergo substantial variations over time, for example when the component is turned “on” and “off”. This thermal cycling can cause substantial stress in the adhesive or other material used to join an electronic component to a substrate because there are typically substantial differences in the coefficients of thermal expansion (“CTE”) of the component, the substrate and the adhesive. For example, silicon, which is typically used to fabricate IC chips, has a CTE of 3.5×10⁻⁶/° C., while copper, which is a good heat sink material, has a CTE of 16.6×10⁻⁶/° C.

Solder alloys have high thermal conductivities, but using solder paste to join two surfaces presents difficulties. Solder particle surfaces typically contain an oxide layer, which has to be removed or cleaned with a flux. After soldering, flux residues must be removed. Flux removal for large area substrates can be a problem, as the flux can be trapped within the solder. Another problem with flux soldering is voiding within the solder. Flux residues can be corrosive and the presence of both flux residues and voids can impair the strength and conductivity of the joint. Soldering works well if both surfaces to be joined are metallic and compatible with the selected solder alloy. However, solder does not work well when one or both of the surfaces is non-metallic, such as ceramic. Soldering to silicon, which is a metalloid, is difficult in practice.

Finally, ease of manufacture, ease of use, cost, reliability and safety are important factors for a thermal adhesive for joining electronic components to substrates or other surfaces.

### SUMMARY OF THE INVENTION

Therefore, one object of the present invention is to provide a high conductivity thermal interface adhesive for mounting electronic components on heat receiving surfaces or substrates to facilitate dissipation of heat.

A further object of the present invention is to provide a thermal interface adhesive for use with heat producing electronic components which is robust, such that it will withstand thermal cycling and other mechanically induced stresses.

Another object of the present invention is to provide a thermal interface adhesive which is reliable, relatively easy to manufacture and use, relatively low cost, and safe.

The present invention is generally directed to thermally conductive adhesive paste compositions, and methods of using such compositions, to join heat-producing electronic components to heat-receiving surfaces, such as heat spreaders and heat sinks, such that the heat generated by said electronic components is efficiently dissipated.

In one aspect, the adhesive paste composition comprises a mixture of solder powder (i.e., fine particles of solder), flux and a curable polymer. Preferably, the polymer is thermally curable, such that when the mixture is heated the solder melts and reflows before the adhesive hardens. According to one aspect of the present invention, the adhesive paste composition has a thermal conductivity of about 15 W/m-K or more after it has been cured. The solder preferably has a low melting point, such as a melting point of about 235° C. or less. Exemplary solder materials which are useful in practicing the present invention include alloys of Sn/Bi, Sn/Pb, Sn/Zn, Sn/Ag, Sn/Cu, Sn/Ag/Cu, and Sn/Ag/Cu/Bi. Other solder alloys with melting point of 235° C. or less may be used as well. The solder preferably has a thermal conductivity of about 20 W/m-K or more, and may comprise 40%-60% of the volume of the adhesive mixture. The polymer may be based on epoxy, silicone, cyanate ester or other thermosetting polymer systems. Preferably, the curable polymer is a liquid at room temperature, and the adhesive interface mixture is formed at room temperature or at a slightly elevated temperature.

In a second, more preferred embodiment, the adhesive paste composition further comprises a high melting point metallic filler material. As used herein the term “high melting point”, when used in reference to a metallic filler material, means that the material has a melting point which is sufficiently high that it does not melt during processing of the interface adhesive, i.e., when the adhesive paste is heated to the highest temperature necessary to cause solder reflow and to cure the polymer. The metallic filler material preferably has a thermal conductivity of about 400 W/m-K or more. Exemplary metallic filler materials include particles of silver or copper, or combinations thereof. The filler material is added to the adhesive mixture in powdered (i.e., particulate) form, with the mean particle size of the metallic filler powder preferably being in the range of about 0.01 mm to about 0.1 mm. The particles of metallic filler material may be coated with solder prior to being added to the mixture. When a metallic filler material is used, the combination of filler and solder preferably comprises about 40%-60% of the volume of the adhesive mixture.

The inventive adhesive mixture may be used as an interface to join a heat generating electronic component, such as an IC chip, to a heat receiving substrate, such as a heat spreader or heat sink, which may be actively cooled. The two surfaces to be joined may have different coefficients of thermal expansion. The mixture, preferably in paste form, is applied to one or both of the surfaces to be joined, for example by dispensing, spreading or by screen printing. After the two surfaces to be joined are positioned in opposing relationship with a desired thickness of adhesive paste therebetween, the adhesive paste is heated, thereby causing the solder to melt and reflow. After the solder has melted the mixture may be heated further at the same or a different temperature to fully cure the polymer. Preferably, the thickness of the final, cured adhesive interface layer is less than about 0.2 mm

### BRIEF DESCRIPTION OF THE DRAWINGS

FIGS. 1A and 1B are schematic cross-sectional side views of a first embodiment of the present invention before and after processing, respectively.

FIGS. 2A and 2B are schematic cross-sectional side views of a second embodiment of the present invention before and after processing, respectively.

### DETAILED DESCRIPTION OF THE PREFERRED EMBODIMENTS

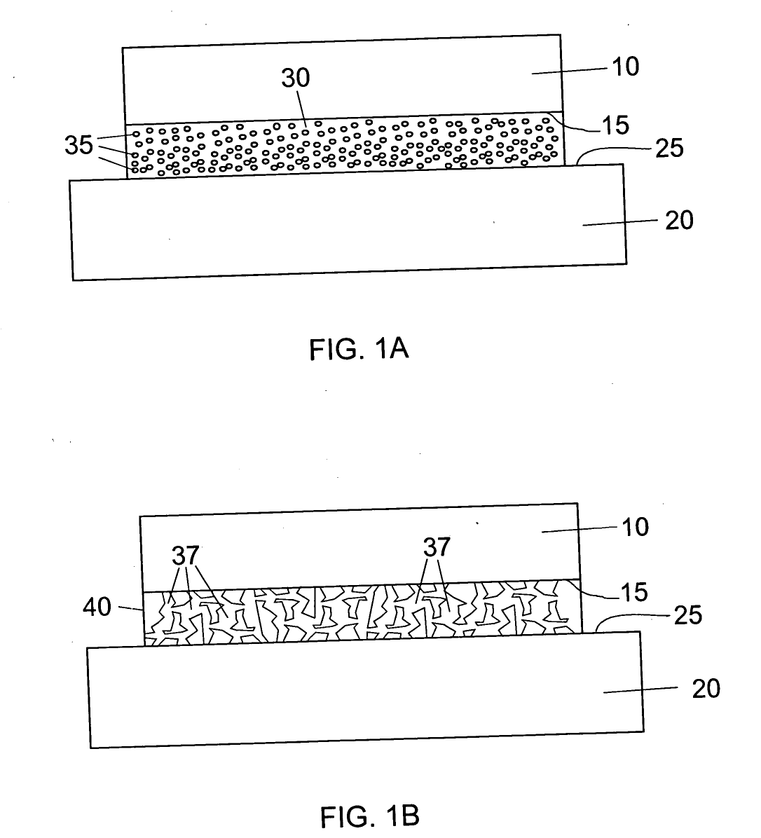

FIGS. 1A and 1B are schematic cross-sectional side views of a first embodiment of the present invention showing a heat producing electronic component 10 having a mounting surface 15 attached to a heat receiving substrate 20 having a heat receiving surface 25 using the thermally conductive interface adhesive of the present invention. FIG. 1A shows the unprocessed adhesive 30, and FIG. 1B shows the processed adhesive 40. The figures are not drawn to scale, but instead are drawn to facilitate understanding of the invention. Thus, for example, the relative thicknesses of unprocessed and processed adhesive layers 30 and 40, and the relative sizes of the particles and structures within such layers, are greatly exaggerated. Likewise, the relative sizes and thicknesses of electronic component 10 and substrate 20 are not intended to be realistic.

Electronic component 10 may, for example, be an IC chip, such as a microprocessor chip, and heat receiving substrate 20 may, for example, be a heat spreader or a heat sink. If necessary to provide adequate cooling, heat receiving substrate 20 can be actively cooled, such as by the forced circulation of a cooling fluid through the body of the substrate or over one or more surfaces of the substrate. Preferably, mounting surface 15 and heat receiving surface 25 are generally flat so that the interface adhesive can be applied in such a manner as to have a substantially uniform thickness between the opposing surfaces. Preferably, the thermal interface layer (both in its processed and unprocessed states) extends over the entire mounting surface of electronic component 10 in order to maximize the surface area available for heat transfer. According to the present invention, heat is dissipated from electronic component 10 to heat receiving substrate 20 by flowing through a layer of thermal interface adhesive layer 40. Accordingly, the thermal interface adhesive of the present invention has a relatively high thermal conductivity. Preferably, the thermal conductivity of thermal interface adhesive layer 40 is about 15 W/m-K or more. Nonetheless, the thermal conductivity of a preferred heat receiving substrate 20 is significantly higher. Accordingly, it is preferable to keep the thickness of layer 40 low, consistent with the need to provide good adhesion. Preferably, layer 40 is about 0.2 mm thick or less.

An unprocessed adhesive mixture, the details of which are described below, is applied in paste form to one or both of surfaces 15 and 25. Application of the adhesive mixture can be by any suitable means for applying a paste, including, for example, by dispensing, screen printing or by application with a blade or other device for spreading. Surfaces 15 and 25 are then brought into opposing relationship at a desired separation distance, such that the entire volume between electronic component 10 and substrate 20 is filled with the adhesive mixture to form layer 30. In order to ensure good thermal conductivity between component 10 and substrate 20, it is important that no voids be present in layer 30. Preferably a controlled amount of pressure is applied to urge the opposing surfaces together.

According to the embodiment of FIG. 1A, the unprocessed adhesive mixture in layer 30 comprises a liquid polymer composition or carrier, powdered solder and flux. Thus, as depicted in FIG. 1A, unprocessed adhesive layer 30 comprises a large number of discrete particles of solder powder some of which are labeled with the reference number 35. The term “solder” is used herein in a broad sense and refers to any metallic composition or alloy characterized by a relatively low melting point and which has reflow properties upon being melted, and a thermal conductivity consistent with the purposes of the invention. Preferably, in the first embodiment, the solder powder comprises between about 40% to about 60% of the volume of the mixture, and the particles are relatively uniform in size with a mean diameter of 0.005 to 0.05 mm. However, solder powder with particles of various shapes and sizes may be used in connection with the present invention. Preferably, the solder has a relatively low melting point of about 235° C. or less. Exemplary solders useful in connection with the present invention include alloys of Sn/Bi, Sn/Pb, Sn/Zn, Sn/Ag, Sn/Cu, Sn/Ag/Cu, Sn/Ag/Cu/Bi, or other solder alloys with melting point of 235° C. or less, with the proportions of the individual solder components being adjusted according to need. Preferably, the solder composition has a thermal conductivity of about 20 W/m-K or more. (For purposes of the present invention, reference to the thermal conductivity of solder or other metallic material or metal alloy is intended to refer to the conductivity of the material in bulk form, as opposed to the thermal conductivity in a powdered state.)

Suitable polymers for formulating the polymer composition include epoxies, silicone, cyanate ester or other thermosetting polymers. As is well known, a suitable polymer matrix may include multiple components, such as a resin and a curing agent. A polymer composition for an epoxy-based compound typically includes an epoxy resin, a curing agent, and a catalyst. The epoxy resin may be based on bisphenol-A, bisphenol-F, epoxidized novolac, or cycloaliphatic epoxides. Other types and blends of two or more epoxides may be used. Typical curing agents include amines, anhydrides, phenolics, novolacs, or other curatives suitable for curing epoxy resins. Typical catalysts include metal acetylacetonates, imidazoles, and other types of nitrogen and/or phosphorus-containing compounds. Preferably, the polymer composition includes a flux for removing oxides from metal surfaces. Upon heating, the flux component cleans and removes oxides from surfaces of metals and solder particles. When the adhesive mixture is heated above melting point of solder, the solder melts and reflows. Preferably, the polymer is thermosetting and the polymer composition is formulated to allow solder to melt and reflow before the adhesive hardens. Thus, the unprocessed adhesive mixture can be heated to a temperature which is sufficiently high to cause the solder to melt and reflow within the polymer matrix before any substantial hardening of the polymer.

Preferably the polymer matrix or carrier is relatively low viscosity, such that the unprocessed adhesive paste is readily spreadable and has good flow properties so that no voids are present between surfaces 15 and 25 when layer 30 is applied. In addition, low viscosity is important to enable the dispersion of a high volume of particles within the matrix and to allow the solder to easily flow within the matrix when melted to form a network of interconnected metallic structures as described below.

Preferably, the polymer matrix is substantially non-volatile, such that little or no gas is released during processing. Release of gases into the matrix would create voids in adhesive layer 40, thereby reducing the strength and thermal conductivity of the layer. Finally, after being cured the polymer should provide good adhesion and have sufficient elasticity to absorb any stresses generated by thermal cycling or other mechanical causes. Good adhesion is necessary not only to ensure that component 10 remains securely fastened to substrate 20, but also to avoid the creation of microscopic gaps between adhesive layer 40 and surfaces 15 and 25 which would degrade thermal performance.

The flux, also referred to as a fluxing agent, can include any material suitable for removing oxides from the surfaces of the powdered solder and surfaces 15 and 25. The flux preferably comprises an organic acid. Organic acids are preferred because they can have relatively high boiling points. Exemplary fluxing agents can include cinnamic acid, succinic acid, gluteric acid, adipic acid, pimelic acid, suberic acid, azelaic acid, sebacic acid, precursors and combinations thereof. The flux is also preferably substantially non-volatile and, as is well known, should have a relatively low melting point. The selection of the particular fluxing agent may depend on the type of solder (and, therefore, the composition of the oxides which form on the surfaces thereof) used in the adhesive mixture, and on the materials from which surfaces 15 and 25 are made. As is disclosed in co-assigned U.S. Pat. No. 6,281,040, (the full disclosure of which is hereby incorporated by reference) in one embodiment the flux may also serve as a curing agent for the polymer matrix.

Additional materials, such as inhibitors, binders, thinning agents, coupling agents and the like, may be added to the unprocessed adhesive paste, consistent with the invention.

The unprocessed adhesive paste is formed by combining the various components (e.g., the powdered solder, the polymer matrix, and the flux) and thoroughly mixing them to create a homogenous blend. Any suitable mixing means may be used. Preferably, the ingredients are mixed at room temperature or slightly heated if necessary, for example below about 80° C., and the mixing is performed such that the chemical properties of the ingredients are not altered.

After the unprocessed adhesive is mixed and applied, as described above, such that the “sandwich” structure depicted in FIG. 1A has been formed, layer 30 is processed. Such processing initially comprises heating layer 30 to cause solder particles 35 to melt and reflow and, thereafter, curing the polymer matrix. Upon being melted, solder particles 35 reflow and coalesce to form a metallic network 37 within the polymer matrix, as depicted in FIG. 1B. This metallic network 37 provides a thermally conductive flow path which, according to the present invention, dissipates heat generated by electronic component 10 by transferring it to heat receiving substrate 20. After the solder has been melted to form metallic network 37, the polymer matrix is cured by further heating.

Thus, a two-step heating process may be employed, wherein the adhesive mixture is heated to a first temperature to melt the solder and, thereby form network 37, and then may be further heated at a different temperature to cure the polymer. The optimal curing temperature for the polymer may be different, either lower or higher, than the temperature applied to melt the solder. Typically, the curing time is much longer than the time required to melt and reflow the solder. Thus, even if the polymer begins curing at a non-optimal temperature used to melt the solder, the duration during which this occurs will be relatively short. This two-step process can be accomplished by simply ramping the temperature up and down, linearly or otherwise, such that the temperature is gradually increased to the temperature needed for melting the solder, and then ramped to the optimal temperature for hardening the polymer. Alternatively, the temperature can be raised in steps. In any case, it is important that there be a sufficient interval between the time the solder begins to melt and the time the polymer hardens to allow for the formation of solder network 37. Accordingly, it may be preferable, depending on the relative melting temperature of the solder and curing temperature of the polymer, to use a slow-curing polymer matrix. It is noted that the effect of heating the polymer may, initially, be to further lower the viscosity making it easier for the melting solder to flow through the matrix.

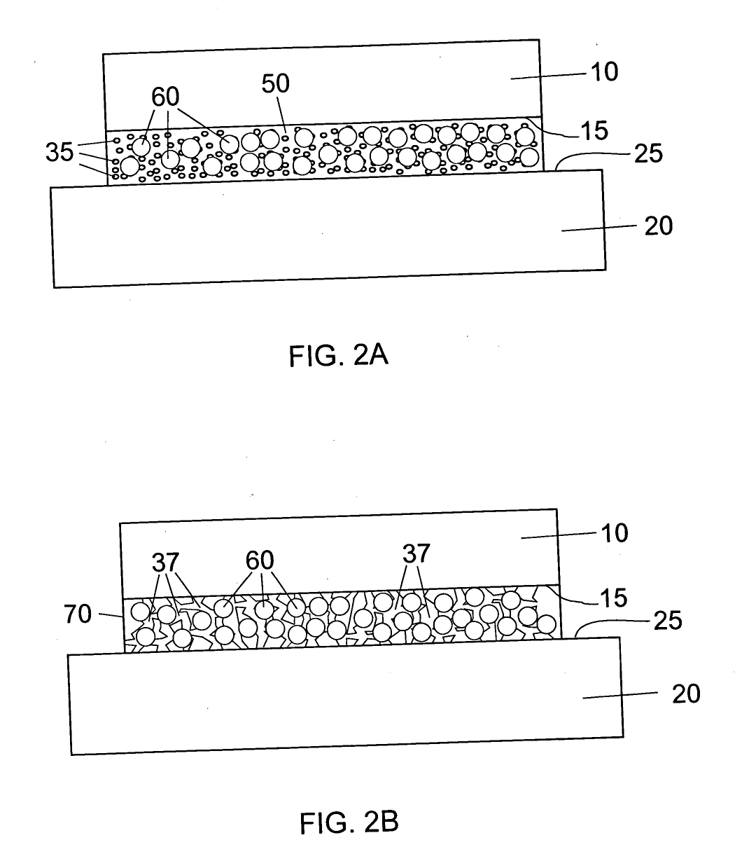

A second, more preferred embodiment of the invention is now discussed in connection with FIGS. 2A and 2B. The embodiment of FIGS. 2A and 2B is very similar to the embodiment of FIGS. 1A and 1B, except that particles of a high melting point metallic filler material 60 are added to the interface adhesive. (As noted above, the term “high melting point” is strictly relative, meaning that the filler material does not melt at the highest temperature encountered during processing.) Thus, FIG. 2A depicts an unprocessed adhesive layer 50 containing metal filler particles 60 in addition to solder particles 37. For convenience, FIG. 2A depicts the metal filler particles as being round and much larger than the solder particles. However, no particular size relationship or shape is required for the present invention, other than preferred mean particle size range of 0.005 to 0.05 mm for solder particles and 0.01 to 0.1 mm for metal filler particles.

FIG. 2B depicts the final, cured adhesive layer 70, after solder reflow, showing the presence of unaltered metallic particles 60 in a solder network 37, formed during processing by melting the solder and causing it to reflow, in the same manner as described above. Because the metallic filler particles play an important role in enhancing the thermal conductivity of the interface adhesive of the second embodiment of the present invention, it is important that good metallurgical contact is made between the solder and the metallic filler particles. In order to ensure good contact, the selection of the proper fluxing agent is important. Specifically, a flux should be selected that removes any oxides formed on the filler particles, in addition to the solder particles and surfaces 15 and 25. In one embodiment, some or all of filler particles 60 are coated with solder prior to being mixed into the unprocessed adhesive paste. Pre-coating the filler particles with solder facilitates the formation of good metallurgical bonds between the metallic filler particles 60 and the solder network 37.

Preferably, metallic filler particles 60 have a high thermal conductivity, for example more than about 400 W/m-K. Suitable filler materials include silver and copper, or a combination thereof, having a particle size in the range of about 0.01 mm to about 0.1 mm. Thus, in accordance with the present invention, the metallic filler particles preferably have a much higher thermal conductivity than the solder. Preferably, the combination of solder powder and metallic filler comprises about 40 to 60% by volume of the adhesive mixture.

While the present invention has been particularly described with respect to the illustrated embodiments, various alterations, modifications and adaptations may be made based on the present disclosure, and are intended to be within the scope of the present invention. For example, additives not specifically discussed herein can be included in the interface adhesive without departing from the scope and the spirit of the invention. While the invention has been described in connection with what is presently considered to be the most practical and preferred embodiments, it is to be understood that the present invention is not limited to the disclosed embodiments but, on the contrary, is intended to cover various modifications and equivalent arrangements included within the scope of the appended claims.

1. A method of dissipating heat generated by an electronic component, comprising the step of attaching the electronic component to a heat receiving surface using a thermal adhesive, wherein the thermal adhesive comprises:
a mixture of a curable polymer composition, a solder powder, and a fluxing agent, and
wherein the step of attaching comprises heating said mixture to a temperature above the melting point of said solder powder, such that the solder reflows to form interconnecting metal structures dispersed in the polymer matrix, and thereafter curing the polymer matrix.

2. The method of claim 1 wherein said mixture contains 40% to 60% solder powder by volume.

3. The method of claim 1 wherein said mixture further comprises metallic particles having a high melting point.

4. The method of claim 3 wherein said metallic particles have a thermal conductivity of about 400 W/m-K or more.

5. The method of claim 3 wherein the combined volume percentage of metallic particles and solder in said adhesive mixture after it has been cured is about 40 to 60%.

6. The method of claim 3 wherein said metallic particles are copper, silver or a combination thereof.

7. The method of claim 3 wherein said metallic particles have a mean particle size in the range of about 0.01 mm to 0.1 mm.

8. The method of claim 3 wherein at least some of said metallic particles are coated with solder prior to being incorporated into said mixture.

9. The method of claim 1 wherein said polymer matrix is a liquid at room temperature.

10. The method of claim 6 wherein said mixture is formed at less than 80° C.

11. The method of claim 1 wherein said polymer matrix is cured by further heating after the solder has melted and reflowed.

12. The method of claim 1 wherein said electronic component is an IC chip.

13. The method of claim 1 wherein said heat receiving surface is a surface of a heat spreader or heat sink.

14. The method of claim 1 wherein said heat receiving surface is actively cooled.

15. The method of claim 1 wherein said thermal adhesive has a thermal conductivity of about 15 W/mK or more.

16. The method of claim 1 wherein said mixture is dispensed or screen printed onto either said electronic component or onto said heat receiving surface.

17. The method of claim 1 wherein the coefficient of thermal expansion of said electronic component is different than the coefficient of thermal expansion of said heat receiving surface.

18. The method of claim 1 wherein said thermal adhesive has a thickness less than about 0.2 mm.

19. The method of claim 1 wherein said solder has a melting point of about 235° C. or less.

20. The method of claim 19 wherein said solder has a thermal conductivity of about 20 W/m-K or more.

21. The method of claim 20 is selected from the group consisting of alloys of Sn/Bi, Sn/Pb, Sn/Zn, Sn/Ag, Sn/Cu, Sn/Ag/Cu, and Sn/Ag/Cu/Bi.

22. The method of claim 1 wherein said polymer matrix comprises an epoxy, a silicone or a cyanate ester.

23. A method of attaching a heat producing electronic component to a heat receiving substrate, comprising:
forming an adhesive paste comprising a mixture of solder particles, a fluxing agent and a liquid polymer,
placing said adhesive paste between a mounting surface of said electronic component and an opposing surface of said heat-receiving substrate,
thereafter, heating the assembly to a temperature sufficiently high to cause said solder particles to melt and reflow,
thereafter curing said polymer such that the adhesive paste hardens.

24. The method of claim 23 wherein said mounting surface and said opposing surface are substantially flat and are separated by a distance of about 0.2 mm or less.

25. The method of claim 24 wherein said adhesive paste further comprises particles of a metallic filler material having a high melting point.

26. The method of claim 25 wherein said metallic filler material comprises silver or copper.

27. The method of claim 25 wherein at least some of said metallic particles are precoated with solder prior to being added to said mixture.

28. The method of claim 23 wherein said polymer is thermosetting and has an optimal curing temperature which is different than the melting point of said solder.

29. The method of claim 23 wherein said polymer is relatively low viscosity.

30. The method of claim 25 wherein said mixture comprises more than about 40 to 60% by volume of filler and solder.

31. The method of claim 23 wherein said electronic component and said heat receiving substrate have substantially different coefficients of thermal expansion.

32. A thermal interface adhesive, comprising:
solder particles,
flux material,
metallic filler material having a high melting point, and
a thermally curable polymer composition,
wherein said metallic filler material has a thermal conductivity of about 400 W/m-K or more, said solder particles have a thermal conductivity of about 20 W/m-K or more, the combination of said metallic filler material and said solder particles comprise about 40 to 60% by volume of said thermal interface adhesive, and
wherein said thermal interface adhesive has a thermal conductivity of about 15 W/m-K or more after it has been cured.
